(19) United States
(12) Patent Application Publication
(10) Pub. No.: US 2026/0119502 A1
(43) Pub. Date: Apr. 30, 2026

(54) MECHANISMS FOR REDUCING PROBE-SIDE SPILL IN HASH JOINS

(71) Applicant: Salesforce, Inc., San Francisco, CA (US)

(72) Inventors: Rui Zhang, Fremont, CA (US); Colm McHugh, Dublin (IE); Yi Xia, Los Angeles, CA (US)

(21) Appl. No.: 18/928,335

(22) Filed: Oct. 28, 2024

(51) Int. Cl. G06F 16/2455; G06F 16/22

(52) U.S. Cl. CPC G06F 16/2456; G06F 16/2255

(57) ABSTRACT

In an embodiment, a computer system performs a hash join. During a build phase, the computer system constructs a hash table in memory based on rows of a first table. The constructing may result in build batches of rows, including one build batch stored in memory and multiple build batches stored in a storage. The computer system determines whether any of the multiple build batches is skewed according to a data skew condition. In response to determining that there is at least one build batch that is skewed, the computer system loads one or more of the multiple build batches into memory such that there are at least two build batches stored in memory. During a probe phase, the computer system identifies, based on the at least two build batches stored in memory, rows of a second table to join with the rows of the first table.

### BACKGROUND

### Technical Field

This disclosure relates generally to database systems and, more specifically, to various mechanisms for reducing probe-side spill in hash joins.

### Description of the Related Art

In the field of database management, hash join operations (or simply, hash joins) are a technique that can be employed to combine data from two distinct tables by utilizing a set of common column values, referred to as join keys. The process typically involves a build phase, where a hash table is constructed in memory from the smaller table, and a probe phase, where the larger table is scanned for rows that correspond to the hash keys in the hash table. In some cases, memory limitations on the allocated space in memory may necessitate the use of a hybrid hash join strategy, where the hash table is divided into multiple batches, with one batch retained in memory and the remaining batches stored on disk. This strategy may allow for the efficient processing of large tables that exceed the capacity of allocated space in memory.

### BRIEF DESCRIPTION OF THE DRAWINGS

FIG. 1 is a block diagram illustrating one embodiment of a system that is operable to reduce probe-side spill in hash join operations.

FIG. 2A is a block diagram illustrating one embodiment of a build phase of a hash join operation in which a hash table is constructed in memory using rows of an inner table without spilling any rows of the inner table to disk.

FIG. 2B is a block diagram illustrating one embodiment of a build phase of a hash join operation in which a hash table is constructed in memory using rows of an inner table but at least some rows of the inner table are spilled to disk.

FIG. 3 is a block diagram illustrating one embodiment of a part of a reload phase of a hash join operation in which build batches on disk that are skewed are identified according to a skew rule and added to a skewed batch list.

FIG. 4 is a block diagram illustrating one embodiment of a part of the reload phase in which non-skewed build batches are loaded from disk into memory.

FIG. 5 is a block diagram illustrating one embodiment of a probe phase of a hash join operation in which rows of the outer table are checked against rows in the hash table.

FIG. 6 is a block diagram illustrating one embodiment of another portion of a hash join operation in which build batches in memory are removed, other build batches are loaded from disk into memory, rows of corresponding probe batches are checked against rows of the loaded build batches, and matched rows are emitted.

FIGS. 7-8 are flow diagrams illustrating example methods relating to performing a hash join operation, according to some embodiments.

FIG. 9 is a block diagram illustrating elements of a computer system for implementing various systems described in the present disclosure, according to some embodiments.

### DETAILED DESCRIPTION

A hash join operation typically involves a build phase and a probe phase. During the build phase, a hash table is constructed on an inner table or relation (e.g., the result of a sub-plan) using join key(s) as the hash lookup key. Once the hash table has been constructed, the hash join operation proceeds to the probe phase, where the outer table or relation is scanned, and for each row or tuple from the outer relation, a hash table-lookup is performed to determine whether there is a match between the outer tuple and the inner relation. Memory limitations on the allocated space in memory used to house the hash table may necessitate the use of a hybrid hash join strategy, where the hash table is divided into multiple batches, with one batch retained in memory and the remaining batches stored on disk.

In some cases, the performance of hybrid hash joins may be significantly impacted by the occurrence of probe-side spilling, where rows from the probe phase that do not find a match in the in-memory batch are written to disk. This spilling may be exacerbated when the inner table exhibits data skew, leading to an uneven distribution of its rows across the batches and resulting in a disproportionate number of rows being mapped to a single batch. As the number of batches increases, so may the volume of probe-side spilling, leading to excessive disk I/O that severely degrade the hash join operation's performance. For example, when the build side hash table comprises two batches, half of the rows of the outer table will need to be spilled to disk assuming uniform data distribution. In general, assuming uniform data distribution, the more batches the build phase produces, the more rows the probe phase will spill. In the ideal case where the build side hash table comprises all the inner rows in a single batch, nothing in the probe phase will spill.

When the build side table exhibits data skew, as the number of batches increases, the in-memory batch is more likely to contain fewer rows than it might otherwise have if there was no data skew. As a result of containing fewer rows, the rows from the outer table are less likely to find a match in the in-memory batch and thus have to be spilled to disk, leading to excessive disk I/O. Accordingly, this disclosure addresses, among other things, the technical problem of how to reduce probe phase spilling, especially in the presence of skewed data.

In various embodiments described below, a system includes a database and a database node that performs a hash join operations involving an inner table and an outer table. The hash join operation may involve a build side (also referred to as a build phase) in which a hash table is built in memory based on rows of the inner table, and a probe side (also referred to as a probe phase) in which rows of the outer table are checked against the hash table to find matches based on certain criteria. In various cases, the hash table is divided into multiple partitions or batches. A single batch may be kept in the system's memory, while the others may be stored separately on disk during the build phase. The system may encounter cases where there is an imbalance in data distribution (data skew) after it has completed the build phase. The system may identify this skew by comparing the sizes of the build batches to the overall size of the inner table used in the build phase. If a batch's size (e.g., its row count) is at least a threshold percentage (e.g., 30%) of the inner table's size, it may be labeled as skewed.

Once the system has identified the presence of data skew from the build side, it may attempt to optimize memory usage during a reload phase (occurring between the build phase and the probe phase) by transferring as many non-skewed batches as possible from disk into memory, given the observation that such batches typically consist of a small number of rows, thereby allowing multiple such batches to be stored in memory simultaneously. This transfer may be done in a sequential manner, where the system checks each batch in turn and skips over any that are skewed. The system may continue this process until adding another non-skewed batch would exceed the capacity of the allocated space in memory. By doing so, the system may increase the likelihood of finding matches in memory during the probe phase and thus may reduce the amount of data that needs to be spilled to disk. This dynamic loading of non-skewed batches into memory may help in utilizing the available space more efficiently and may decrease the need for probe-side spilling.

During the probe phase, the system may attempt to match rows of the outer table with rows stored in the batches that are in memory. A batch identifier (ID) may be generated for a row that indicates to which batch that row belongs. If a row maps to an in-memory batch, then the system may determine if the outer table row matches an inner table row in that in-memory batch. Any matched rows may be emitted as a result of the hash join. But if the batch ID of an outer table row is greater than the largest batch number in memory or matches the identifier of a skewed batch, the system may then write this row to a probe batch on disk. After this initial in-memory probe phase, the system may proceed with a conventional disk spill-based probe, which may remove the batches in memory, load other build batches from disk into memory, and then check rows of corresponding probe batches against the loaded build batches for any matching rows to emit as part of the result for the hash join operation.

Aspects of the subject matter described in this disclosure can be implemented to realize one or more of the following advantages. The described techniques may be implemented to support efficient data processing in database management systems by optimizing the utilization of available memory resources during hash join operations. The approach may allow for a more streamlined processing of join queries by minimizing the need for disk-based operations, which may lead to a reduction in the time required to execute complex queries. The system may adapt to varying data distributions and sizes by dynamically managing memory allocation, which may result in improved system performance and resource management. The identification and handling of skewed data batches may prevent the unnecessary allocation of memory resources, which may contribute to the overall efficiency of join operations.

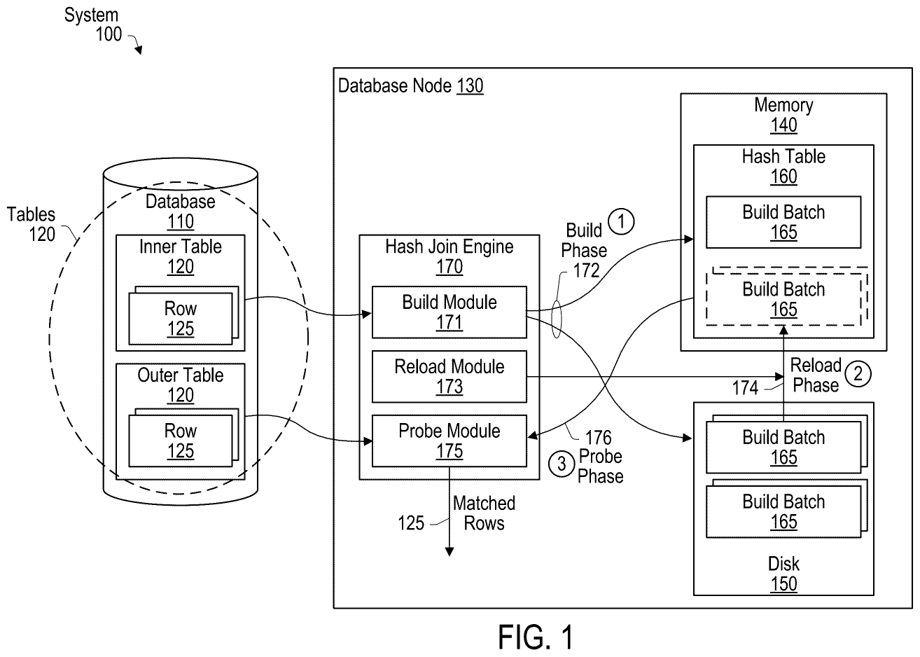

Turning now to FIG. 1, a block diagram of a system 100 is shown. System 100 includes a set of components that may be implemented via hardware or a combination of hardware and software routines. As shown in the illustrated embodiment, system 100 includes a database 110 and a database node 130. Additionally, database 110 includes tables 120 having an inner table 120 and an outer table 120, both of which include rows 125. As shown, database node 130 includes a memory 140, a disk 150, and a hash join engine 170 having a build module 171, a reload module 173, and a probe module 175. As further shown, memory 140 includes a hash table 160 with a build batch 165 and disk 150 includes multiple build batches 165. System 100 may be implemented differently than shown. For example, the contents of database 110 (e.g., tables 120) may be stored on disk 150.

System 100, in various embodiments, implements a platform service (e.g., a customer relationship management (CRM) platform service) that allows users of that service to develop, run, and manage applications. System 100 may be a multi-tenant system that provides various functionality to users/tenants hosted by the multi-tenant system. Accordingly, system 100 may execute software routines from various, different users (e.g., providers and tenants of system 100) as well as provide code, web pages, and other data to users, stores, and other entities that are associated with system 100. In various embodiments, system 100 is implemented using a cloud infrastructure that is provided by a cloud provider. Therefore, database 110 and database node 130 may utilize the available cloud resources of that cloud infrastructure (e.g., computing resources, storage resources, etc.) in order to facilitate their operation. As an example, software for implementing database node 130 might be stored on a non-transitory computer-readable medium of server-based hardware included in a datacenter of the cloud provider and executed in a virtual machine hosted on that server-based hardware. In some cases, database node 130 is implemented without the assistance of a virtual machine or other deployment technologies, such as containerization. In some embodiments, system 100 is implemented utilizing local or private infrastructure as opposed to a public cloud.

Database 110, in various embodiments, is a collection of information that is organized in a manner that allows for access, storage, and/or manipulation of that information. Database 110 may include supporting software (e.g., storage servers) that enables database node 130 to carry out those operations (e.g., accessing, storing, etc.) on the information stored at database 110. In various embodiments, database 110 is implemented using a single or multiple storage devices that are connected together on a network (e.g., a storage attached network (SAN)) and configured to redundantly store information in order to prevent data loss. The storage devices may store data persistently and thus database 110 may serve as a persistent storage for system 100. Further, as discussed, components of system 100 may utilize the available cloud resources of a cloud infrastructure and thus the data of database 110 may be stored using a storage service provided by a cloud provider (e.g., Amazon S3®).

Tables 120, in various embodiments, are database relations that store data in the form of a set of records. Tables 120 may store data in an organized structure that comprises columns and rows 125, where a column defines a field and a row 125 corresponds to a record that stores one or more values for those columns. For example, a field may correspond to usernames and thus a record corresponding to a row 125 in a table 120 may include a value that identifies a username under that field. Accordingly, in various embodiments, a row 125 represents a single record in a table, such as inner table 120 or outer table 120, and comprises a set of values that correspond to a single entity in database 110.

In various embodiments, a hash join operation involves inner table 120 and outer table 120, which may be identified by the query that triggers the hash join operation. In various embodiments, inner table 120 includes data that is used to build hash table 160 during a build phase 172 of the hash join operation. Inner table 120 may correspond to the smaller of the two tables that are involved in the hash join operation in order to reduce the number of rows 125 that are spilled out to disk 150 when constructing hash table 160. In various embodiments, outer table 120 includes data that is probed against hash table 160 after it has been constructed from inner table 120. Outer table 120 may be scanned during a probe phase 176, and its rows 125 may be matched against the corresponding entries in hash table 160. Accordingly, inner table 120 may contain rows 125 that are used to construct hash table 160 while outer table 120 may contain rows 125 to be probed against hash table 160 in order to find matching inner table rows 125.

Database node 130, in various embodiments, provides database services, such as data storage, data retrieval, and/or data manipulation. In various embodiments, a database node 130 is software that is executable on hardware, while in some embodiments, it encompasses both the hardware and the software. The database services may be provided to other components in system 100 or to components external to system 100. For example, database node 130 may receive a transaction request from an application node (not illustrated) to perform a database transaction. A database transaction, in various embodiments, is a logical unit of work (e.g., a specified set of database operations) to be performed in relation to database 110. For example, processing a database transaction may include executing a SQL SELECT command to select one or more rows 125 from one or more tables 120. The contents of a row 125 may be specified in a data record and thus database node 130 may return data records that correspond to the one or more rows. Performing a database transaction can also include database node writing data records to database 110. In various cases, performing a database transaction involves database node 130 performing a hash join operation as part of executing a database statement associated with the database transaction.

Memory 140, in various embodiments, is a main memory of database node 130. Thus, memory 140 may be random access memory (RAM-SRAM, EDO RAM, SDRAM, etc.). In some embodiments, memory 140 corresponds to an in-memory cache/buffer, such as HBase™ memstore. Memory 140 provides temporary storage for storing hash table 160 by storing build batches 165. A build batch 165, in various embodiments, is generated during build phase 172 and includes a subset of rows 125 from inner table 120 that are processed together during the phases of a hash join operation. A given build batch 165 may be one of several batches that make up hash table 160, and may be stored in memory 140 or on disk 150 depending on its size and whether it is skewed. Memory 140 may have a limited capacity (or more specifically, the memory space allocated for storing build batches 165 may be limited to a certain size (e.g., 128 Megabytes), which dictates the number of build batches 165 that can simultaneously be stored in memory 140.

Disk 150, in various embodiments, is a secondary storage of database node 130. Thus, disk 150 may be a hard disk drive, a solid disk drive, etc. In various embodiments, disk 150 stores build batches 165 that cannot be accommodated in memory 140 due to size constraints. In particular, when all rows 125 of inner table 120 cannot be stored in the portion of memory 140 allocated for hash table 160, a number of the rows 125 may be spilled to disk 150. This is done by dividing rows 125 into build batches 165 that may individually fit into memory 140 as part of performing split operations when hash table 160 becomes too large to continue to fit in memory 140 during its construction. During build phase 172 of the hash join operation, one build batch 165 may be kept in memory 140 while the remaining build batches 165 are kept on disk 150 until a reload phase 174 of the hash join operation.

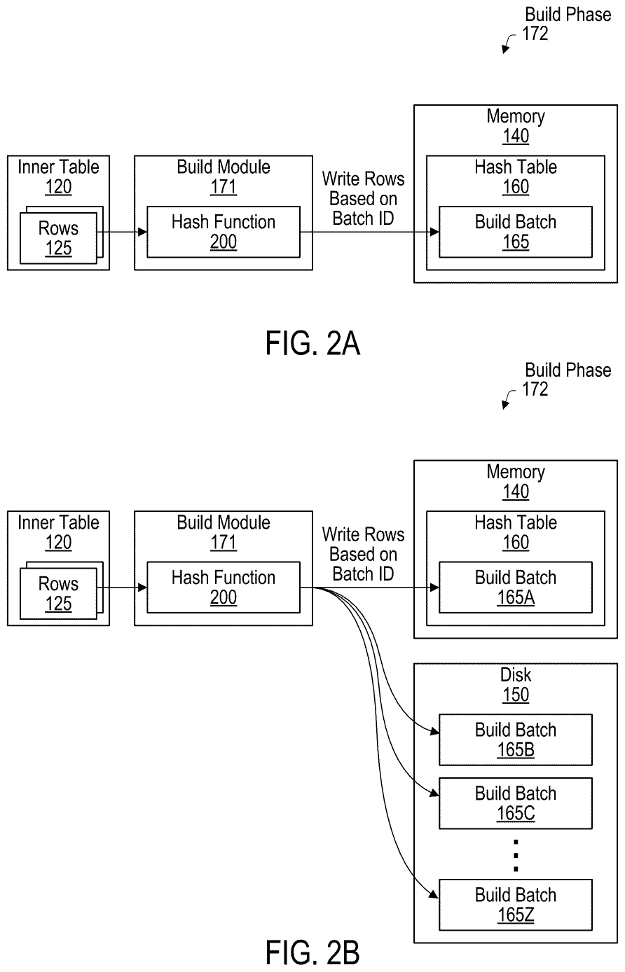

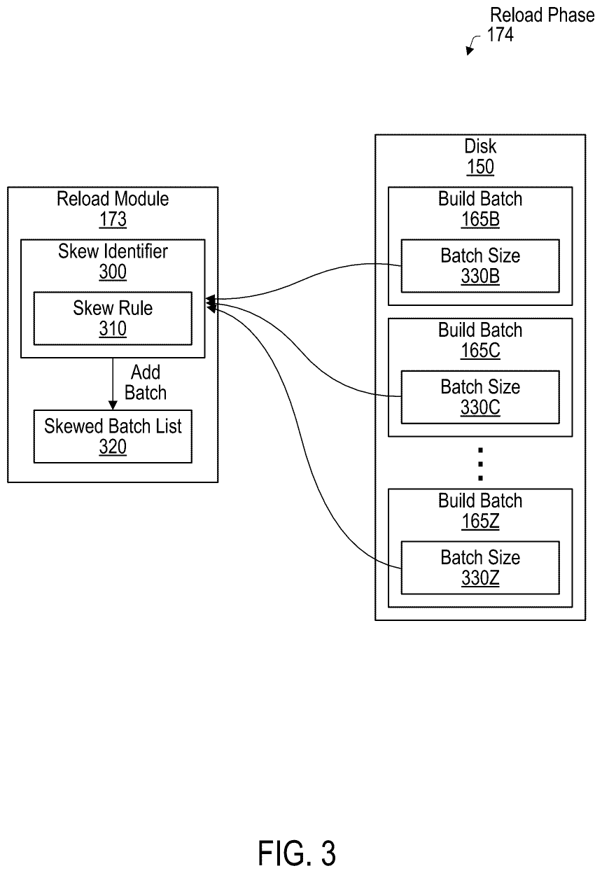

Hash table 160, in various embodiments, is a data structure that stores key-value pairs and provides access to values based on their associated keys. The values may be rows 125 and the keys may be derived from a set of join keys of a hash join—the key for a row 125 may be the values of that row 125 that correspond to the set of join keys. A hash function may be used to compute an index (or hash value) from the key, which determines where the value is stored in an array-based structure. In various embodiments, hash table 160 is constructed from rows 125 of inner table 120 and may be divided into multiple build batches 165, including at least one in-memory build batch 165 and multiple on-disk batches 165, as discussed. In some cases, inner table 120 may fit into memory 140 and thus hash table 160 may comprise only one build batch 165, an example of which is discussed in more detail with respect to FIG. 2A. In many cases, inner table 120 does not fit into memory 140 and thus one or more splitting operations may be performed on hash table 160 to split it into multiple build batches 165, an example of which is discussed in more detail with respect to FIG. 2B.

Hash join engine 170, in various embodiments, is executable software that manages the execution of hash join operations within system 100. Hash join engine 170 may coordinate the build, reload, and probe phases of a hash join operation, invoking various modules that include build module 171, reload module 173, and probe module 175. In various embodiment, build module 171 builds hash table 160 from inner table 120 during build phase 172. Build module 171 may process the rows 125 of inner table 120 to construct hash table 160 by applying a hash function to the join key value(s) of the rows 125 to derive indexes and then inserting the rows 125 into hash table 160 based on their indexes. If hash table 160 becomes too large, then build module 171 may perform a split operation to split hash table 160 into multiple build batches 165. If one or more of those build batches 165 becomes too large, then build module 171 may perform additional split operations on hash table 160.

Multiple factors can determine the number of build batches 165 that are created in build phase 172. First, the memory that is used by hash table 160 may be limited by a configuration parameter, which may be set to 128 Megabytes. Second, the number of rows 125 present in inner table 120 may affect the number of batches; more tuples normally result in more build batches 165 to be used. Third, the length of the projection list in build phase 172 may also be highly-relevant. For an input row 125, it may be transformed to a projected tuple, retaining only the attributes that are required by subsequent query evaluation. Hash table 160 may store the projected tuple inline, meaning that each hash table entry consists of a hash key and the payload that is the actual tuple. For a projection that returns a large number of attributes, and especially if the attributes are wide, the payload in each hash entry can be substantial. As a result, hash table 160 may be able to accommodate just a small number of tuples. Finally, data skew on the build side may significantly affect build batches 165.

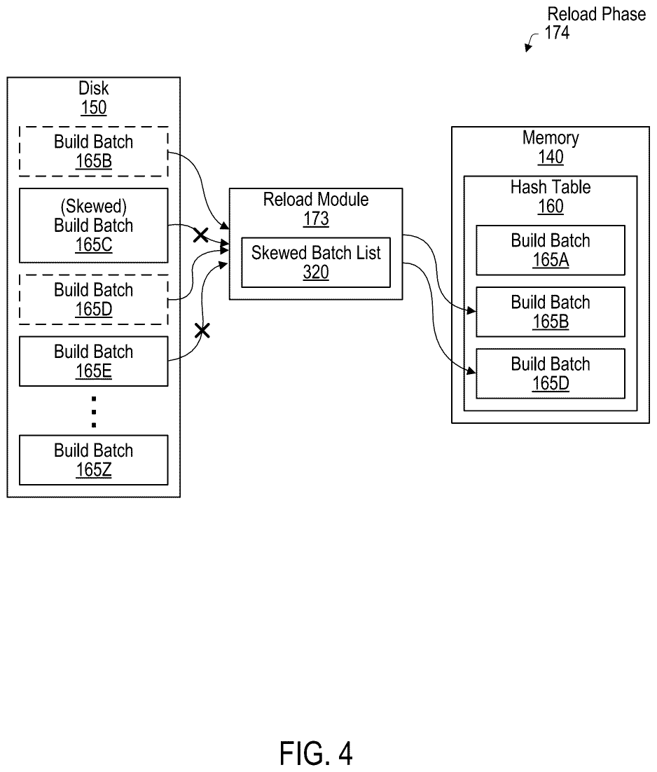

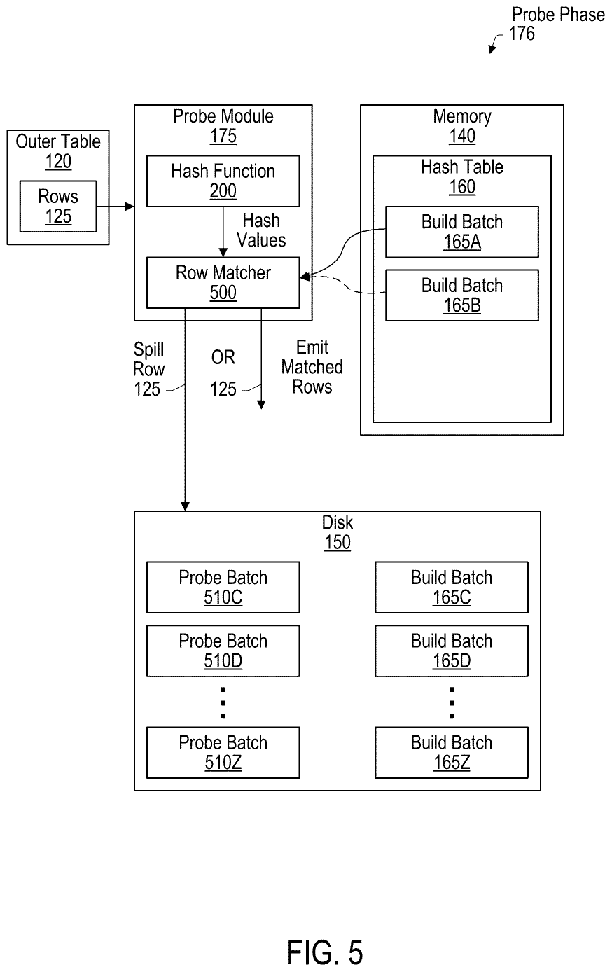

Once all the rows 125 of inner table 120 have been processed and build phase 172 is complete, the hash join operation may transition into reload phase 174 in which one or more build batches 165 are loaded from disk 150 into memory 140. In various embodiments, reload module 173 handles the loading of build batches 165 from disk 150 into memory 140. As such, reload module 173 may determine which build batches 165 are not skewed and can be loaded into memory 140. A process for determining which build batches 165 are skewed is discussed in greater detail with respect to FIG. 3. Reload module 173 may skip over skewed build batches 165 during reload phase 174, as discussed in more detail with respect to FIG. 4. Reload module 173 may selectively load non-skewed build batches 165 into memory 140 to reduce probe-side spilling. In particular, as previously discussed, an outer table row 125 is spilled to disk 150 if this row does not match to the in-memory build batch 165. Accordingly, by maximizing in-memory matching by having multiple build batches 165 in memory 140, such that most of the outer table rows 125 may match against inner table rows 125 in hash table 160 in memory 140, probe-side spill can be minimized.

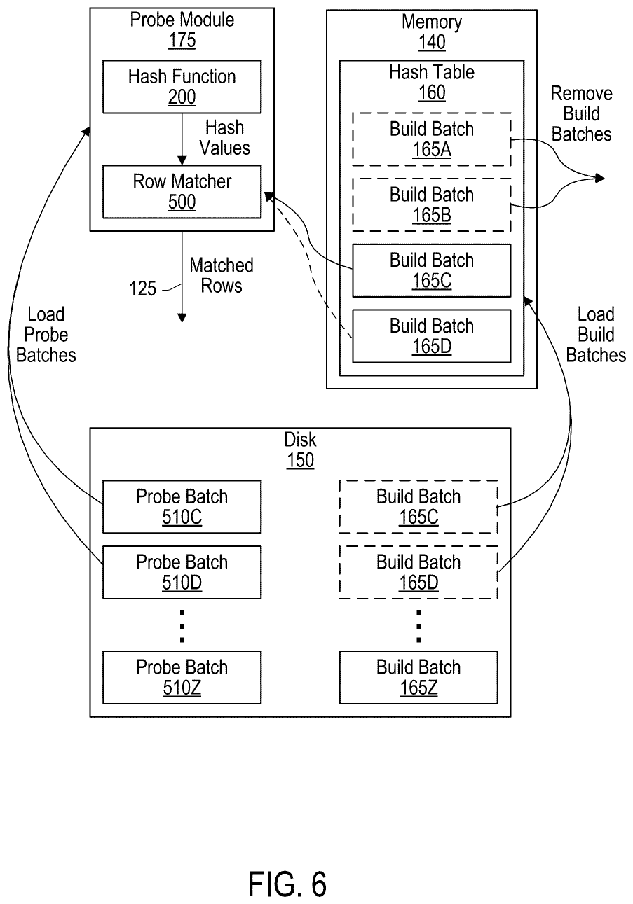

Once one or more build batches 165 have been loaded in memory 140 and reload phase 174 is complete, the hash join operation may transition into probe phase 176 in which rows 125 of outer table 120 are probed against hash table 160 in order to identify any matching rows 125. In various embodiments, probe module 175 perform lookups in hash table 160 for rows 125 of outer table 120 that match rows 125 of inner table 120 based on the set of join keys. As such, probe module 175 may use the hash values of the join keys from rows 125 of outer table 120 to search for corresponding entries in hash table 160. Probe module 175 may emit matched rows 125 when a match is found. An example of probe phase 176 is discussed in more detail with respect to FIG. 5.

In various embodiments, probe module 175 further manages the spilling of rows 125 to disk 150 when necessary. In particular, rows 125 of outer table 120 that do not correspond to the build batches 165 that are in memory 140 may be written to probe batches on disk 150. Those probe batches may have corresponding build batches 165 on disk 150. After probe phase 176 is complete, hash join engine 170 may start one or more additional phases in which build batches 165 are loaded into memory 140 from disk 150. Hash join engine 170 may probe those build batches 165 for matches based on the rows 125 stored in the corresponding probe batches that were generated during probe phase 176.

Accordingly, the components of the system 100 may operate together to execute a hash join operation where build module 171 may construct hash table 160 from inner table 120, and reload module 173 may dynamically load multiple non-skewed build batches 165 from disk 150 into memory 140 when data skew is detected. Probe module 175 may then probe rows 125 from outer table 120 against hash table 160, which now may contain more in-memory batches due to reload module's 173 actions, potentially reducing the amount of probe-side data that needs to be spilled to disk 150. This coordinated operation among build module 171, reload module 173, and probe module 175 may allow for a more efficient use of memory 140 and may minimize the need for probe-side spilling.

Turning now to FIG. 2A, a block diagram of one embodiment of build phase 172 of a hash join operation in which hash table 160 is constructed in memory 140 using rows 125 of inner table 120 without spilling any rows 125 of inner table 120 to disk 150. As shown in the illustrated embodiment, there is inner table 120, build module 171, and memory 140. Also as shown, inner table 120 includes rows 125, build module 171 implements a hash function 200, and memory 140 stores hash table 160 comprising a build batch 165.

As discussed, in various embodiments, build module 171 creates hash table 160 from rows 125 of inner table 120. To facilitate the construction of hash table 160, build module 171 may apply hash function 200 to the join key value(s) of rows 125 to generate index values and insert those rows 125 into hash table 160 based on their respective index value. Hash function 200 may be any of various hashing algorithms that can generate index/hash values from rows 125 of inner table 120. When inserting a row 125 into hash table 160 and there are multiple build batches 165, in various embodiments, build module 171 identifies a build batch 165 to which that row 125 belongs. Build module 171 may identify that build batch 165 based on the index/hash value generated by hash function 200. In particular, in various embodiments, build module 171 considers a set number of bits of the hash value, where the number of bits in the set may change as more build batches 165 are created, as discussed in more detail with respect to FIG. 2B. Based on the value of the set number of bits, build module 171 may determine the batch ID for the associated row 125 and then write that row 125 to the appropriate build batch 165 that matches the batch ID.

FIG. 2A depicts the case in which inner table 120 can fit entirely into memory 140 as a single build batch 165. Accordingly, no splitting operations have to be performed on hash table 160 to split it into multiple build batches 165. Since there are no build batches 165 on disk 150 in this case, there will be no probe-side spilling during probe phase 176. Inner table 120 may correspond to the smaller of the tables 120 involved in a hash join operation in order to reduce the number of build batches 165 as the smaller table 120 is more likely to fit into memory 140. If inner table 120 fits entirely into memory 140, then, in various embodiments, reload phase 174 does not occur and thus the hash join operation transitions from build phase 172 to probe phase 176.

Turning now to FIG. 2B, a block diagram of one embodiment of build phase 172 of a hash join in which hash table 160 is constructed in memory 140 using rows 125 of inner table 120 but some rows 125 of inner table 120 are spilled to disk 150. In the illustrated embodiment, there is inner table 120, build module 171, memory 140, and disk 150. Also as shown, inner table 120 includes rows 125, build module 171 implements hash function 200, memory 140 stores hash table 160 comprising a build batch 165A, and disk 150 stores build batches 165B-C.

FIG. 2B depicts a case in which inner table 120 does not fit entirely into memory 140 (particularly, the space allocated for hash table 160) and thus one or more rows 125 of inner table 120 are written to one or more build batches 165 on disk 150. Thus, build batches 165B-Z may each include a set of rows 125 from inner table 120 that are stored on disk 150 when memory capacity is exceeded. During build phase 172, build module 171 may iterate through the rows 125 of inner table 120, hashing their join key value(s) and inserting them into hash table 160 in memory 140. As it is inserting rows 125 into hash table 160, build module 171 may determine that it has reached a point where cannot insert additional rows 125 into memory 140 as there is no available space. In various embodiments, build module 171 splits hash table 160 from a single build batch 165 into multiple build batches 165 (e.g., two batches 165). One of those build batches 165 is stored in memory 140 while the other build batch 165 is stored on disk 150. Rows 125 of inner table 120 that map to the build batch 165 on disk 150 (e.g., build batch 165B) are stored on disk 150. In various embodiments, a row 125 is mapped to a build batch 165 based on a set number of bits in its hash value. For example, when there are two build batches 165, build module 171 may consider one bit of the hash value to determine the appropriate build batch 165. If the bit is set to “1,” then that row 125 may map to the build batch 165 on disk 150 and thus be written to disk 150.

If, after performing a split operation, one of the build batches 165 exceeds the allocated space in memory 140, then build module 171 may perform another split operation to split hash table 160 again. In certain cases, this additional split operation may be performed only when the in-memory build batch 165 has reached the memory limit of the allocated space in memory 140. In other cases, the additional split operation may be performed when any build batch 165 has reached the memory limit, including those on disk 150. The split operation may double the number of build batches 165. If there are two build batches 165, then this split operation may result in four build batches 165, with one stored in memory 140 and the other three stored on disk 150. The split operation may further result in build module 171 considering an additional bit of a hash value to determine to which build batch 165 that a row 125 belongs. Continuing the previous example, with four build batches 165, build module 171 may consider two bits of the hash value of a row 125 to determine where it belongs.

In various cases, a row 125 is written to different build batches 165 as split operations are performed. As an example, a row 125 may initially be written to build batch 165A before any split operation has been performed. But after a split operation has been performed, build module 171 may determine, based on a bit of the hash value of that row 125, that the row 125 maps to build batch 165B and thus the row 125 may be stored in build batch 165B instead of build batch 165A. After an additional split operation, build module 171 may determine, based on two bits of the hash value of that row 125, that the row 125 maps to build batch 165D and thus the row 125 may be stored in build batch 165D instead of build batch 165B. After another split operation, build module 171 may determine, based on three bits of the hash value of that row 125, that the row 125 maps to a different build batch and thus the row 125 may be stored in that build batch 165 instead of build batch 165D.

In some embodiments, instead of starting with one build batch 165 (i.e., hash table 160 has not been split), build module 171 predicts the number of build batches 165 that is expected to be created and starts build phase 172 with that number, with one stored in memory 140 and the remaining stored on disk 150. Build module 171 may produce the prediction based on the assumption that the rows 125 of inner table 120 will be relatively evenly distributed among the build batches 165. The prediction can be inaccurate due to the lack of statistics describing inner table 120 and thus build module 171 may still perform one or more split operations if it comes out that the data is not evenly distributed and one batch 165 becomes large enough.

Turning now to FIG. 3, a block diagram of one embodiment of a part of reload phase 174 in which build batches 165 on disk 150 that are skewed are identified according to a skew rule 310 and added to a skewed batch list 320. In the illustrated embodiment, there is disk 150 and reload module 173. As shown, reload module 173 includes a skew identifier component 300 (that implements a skew rule 310) and a skewed batch list 320. As further shown, disk 150 stores build batches 165B-Z that have batch sizes 330B-Z, respectively.

As discussed, in various embodiments, reload module 173 may load one or more build batches 165 from disk 150 into memory 140 during reload phase 174 of a hash join operation. At least a portion of reload phase 174 may be performed in response to detecting that at least one build batch 165 is skewed. In various embodiments, reload module 173 selectively loads build batches 165 into memory 140 based on their skew status (e.g., skewed or not skewed) and thus reload module 173 may determine which build batches 165 are skewed.

Skew identifier 300, in various embodiments, identifies build batches 165 that exhibit data skew. Skew identifier 300 may determine skewness by applying predefined criteria, such as those specified by skew rule 310, to assess whether a given batch contains a disproportionate number of rows 125. Accordingly, skew rule 310 may represent a set of criteria used by skew identifier 300 to assess whether a build batch 165 is skewed. In some implementations, skew rule 310 may specify a threshold percentage of rows that qualifies a build batch 165 as skewed. For example, skew rule 310 may dictate that any build batch 165 containing more than 30% of the total rows of inner table 120 (or hash table 160) may be considered skewed.

As shown, skew identifier 300 accesses batch sizes 330B-Z for build batches 165B-Z, respectively, to determine which, if any, of those batches are skewed. The batch size 330 of a build batch 165 may indicate the byte size of that build batch 165, which may be based on the individual byte sizes of the rows 125 in that build batch 165 (some rows 125 may be a few bytes while some are hundreds of bytes for example). The batch size 330 of a build batch 165 may be compared against the total byte size of inner table 120 (or hash table 160) as a part of the skew assessment. If the batch size 330 of a given build batch 165 satisfies skew rule 310 (e.g., the batch size 330 indicates that the given build batch 165 is at least 30% of the size of inner table 120), then skew identifier 300 adds the given build batch 165 to skewed batch list 320. In some embodiments, skew rule 310 may be satisfied by a build batch 165 when a number of rows 125 of that build batch exceeds a threshold number that is based on a total number of rows 125 of inner table 120 (or hash table 160).

Skewed batch list 320, in various embodiments, is a list of batch IDs that correspond to build batches 165 that are identified as skewed. In some implementations, skewed batch list 320 may serve as a reference for reload module 173 to determine which batches should not be loaded into memory 140 and thus skewed batch list 320 can be accessed by reload module 173 when deciding which build batches 165 to transfer from disk 150 to memory 140. An example of loading build batches 165 into memory 140 based on skewed batch list 320 is discussed in more detail with respect to FIG. 4.

Turning now to FIG. 4, a block diagram of one embodiment of a part of reload phase 174 in which build batches 165 are loaded from disk 150 into memory 140 is shown. As shown in the illustrated embodiment, there is memory 140, disk 150, and reload module 173. Also as shown, memory 140 includes hash table 160, disk 150 initially includes build batches 165B-Z, and reload module 173 includes skewed batch list 320.

In various embodiments, in response to determining that there is at least one build batch 165 that is skewed according to skew rule 310, reload module 173 loads build batches 165 into memory 140 from disk 150. Reload module 173 may iterate through build batches 165B-Z in a sequential order that is based on their associated batch IDs. Generally, build batch 165A may be considered batch “0,” build batch 165B may be considered batch “1,” etc. As such, reload module 173 may first consider whether to load build batch 165B. To determine whether a build batch 165 should and can be loaded into memory 140, in various embodiments, reload module 173 determines whether that build batch is skewed and whether there is available, allocated space in memory 140 to store it. As shown in the illustrated embodiment, build batch 165B is not a skewed and there is enough allocated space, so reload module 173 loads build batch 165B into memory 140 from disk 150.

Reload module 173 then considers build batch 165C. As discussed, skewed batch list 320 may be a list of skewed batches that specifies build batches 165 on disk 150 identified as skewed according to skew rule 310. Accordingly, reload module 173 may determine whether build batch 165C is listed on skewed batch list 320. In the illustrated embodiment, build batch 165C is skewed and thus reload module 173 determines to not load build batch 165C. Reload module 173 then considers build batch 165D. In the illustrated embodiment, build batch 165D is not skewed and there is enough allocated space, so reload module 173 loads build batch 165D into memory 140 from disk 150. Reload module 173 then considers build batch 165E. In the illustrated embodiment, build batch 165E is not a skewed. But there is not enough space, so reload module 173 is not able to load build batch 165E.

Accordingly, during reload phase 174, reload module 173 may identify build batches 165 on disk 150 that are skewed according to skew rule 310 and add their batch IDs to skewed batch list 320. Reload module 173 may then iterate through those build batches 165, loading them into memory 140 but excluding the skewed build batches 165. In response to determining that loading another build batch 165 would exceed the memory limit, reload module 173 may then cease the loading of further build batches 165 into memory 140. Reload phase 174 may then complete and probe phase 176 may begin.

Turning now to FIG. 5, a block diagram of one embodiment of probe phase 176 in which rows 125 of outer table 120 are checked against rows 125 in hash table 160 is shown. As shown in the illustrated embodiment, there is outer table 120 (with rows 125), memory 140, disk 150, and probe module 175. As shown, memory 140 includes hash table 160 (with build batches 165A and 165B), disk 150 includes build batches 165C-Z and associated probe batches 510C-Z), and probe module 175 includes hash function 200 and a row matcher component 500.

As discussed, during probe phase 176, probe module 175 may check rows 125 of outer table 120 against rows 125 in hash table 160 and emit matched rows 125 or spill the outer table rows 125 to probe batches 510 on disk 150. In various embodiments, probe module 175 iterates through rows 125 of outer table 120, hashes their join key value(s) using hash function 200 to generate hash values, and passes those hash values to row matcher 500. Row matcher 500, in various embodiments, checks build batches 165A and 165B of hash table 160 that are in memory 140 for matching inner table rows 125 based on the hash values. Row matcher 500 may initially determine whether a given row 125 of outer table 120 maps to build batch 165A or 165B based on that row's batch ID. As discussed, a row 125's batch ID may be derived from a set number of bits of its hash value (e.g., based on the last three bits of the hash value).

In some embodiments, to determine whether a row 125's batch ID maps to a batch ID of a build batch 165 in memory 140, row matcher 500 accesses information that identifies the largest batch ID of the build batches 165 in memory 140. If that row 125's batch ID is greater than the largest batch ID, then the row 125 does not map to a build batch 165 in memory 140. In some embodiments, row matcher 500 accesses information that identifies the batch ID for each build batch 165 in memory 140. If that row 125's batch ID does not match one of those batch IDs, then the row 125 does not map to a build batch 165 in memory 140. If a row 125 does not map to an in-memory build batch 165, then row matcher 500 may write it to a probe batch 510 on disk 150. In various embodiments, a row 125 is written to the probe batch 510 having the same batch ID as the row 125's build batch ID. Furthermore, in some embodiments, row matcher 500 determines whether a row 125's batch ID maps to a skewed build batch 165 (e.g., based on skewed batch list 320). If a row 125 maps to skewed build batch 165 as its batch ID maps to the skewed batch's batch ID, then row matcher 500 may write that row 125 to a probe batch 510 on disk 150.

In some cases, a build batch 165 may be empty. As such, if an outer table row 125 has a batch ID that maps to an empty build batch 165, then row matcher 500 may not write that row 125 to a probe batch 510 on disk 150 because that row 125 is guaranteed to not match an inner table row 125 as the corresponding build batch 165 is empty. Accordingly, row matcher 500 may omit a row 125 by not writing that row 125 to disk 150 based on the row mapping to an empty build batch 165. But the row 125 may be retained if the hash join operation is an anti-join. Note that, in this case, the row 125 is directly emitted as a qualifying row (for an anti-join) and need not be spilled to disk 150.

Further, in some embodiments, hash table 160 may be further split when processing an on-disk build batch 165. The further split may increase the set number of bits used to compute the batch ID by one. As a result, a row that is located previously in batch 165C (for example) may now be assigned to batch 165H. To avoid the complication in dealing with splitting, the in-memory batches 165 may be prevented from being split. As such, the computation of in-memory batch IDs may use the original set of bits determined when hash table 160 is initially created and populated. For an outer table row 125, in various embodiments, row matcher 500 uses the original batch ID of that row 125 to determine whether it matches a skewed batch and thus shall be spilled to disk 150. When spilling to disk, the batch ID that is assigned to that outer table row 125 may be computed using the new set of bits to match the build batch 165 in the last stage of the join operation. That is, when determining whether an outer table row 125 can be mapped to an in-memory build batch 165, the batch ID of that row may be computed using the original set of bits. If and when that row is spilled to disk, it may be assigned a batch ID computed from the new set of bits after the split operations. Accordingly, a row 125 may be written to a probe batch 510 based on a second batch ID associated with that row in response to one or more split operations being performed on a build batch 165 that is associated with a first batch ID of that row.

If a row 125 maps to an in-memory build batch 165, then row matcher 500 performs a look up in hash table 160 to determine whether that outer table row 125 matches an inner table row 125 stored in build batches 165A or 165B of hash table 160. Row matcher 500 may index into hash table 160 based on the outer table row's hash value to determine if there is an inner table row 125 that is stored at the indexed entry. If there is a matching inner table row 125, then row matcher 500 may join the outer table row 125 and the inner table row 125 and return them as part of a result of the hash join operation.

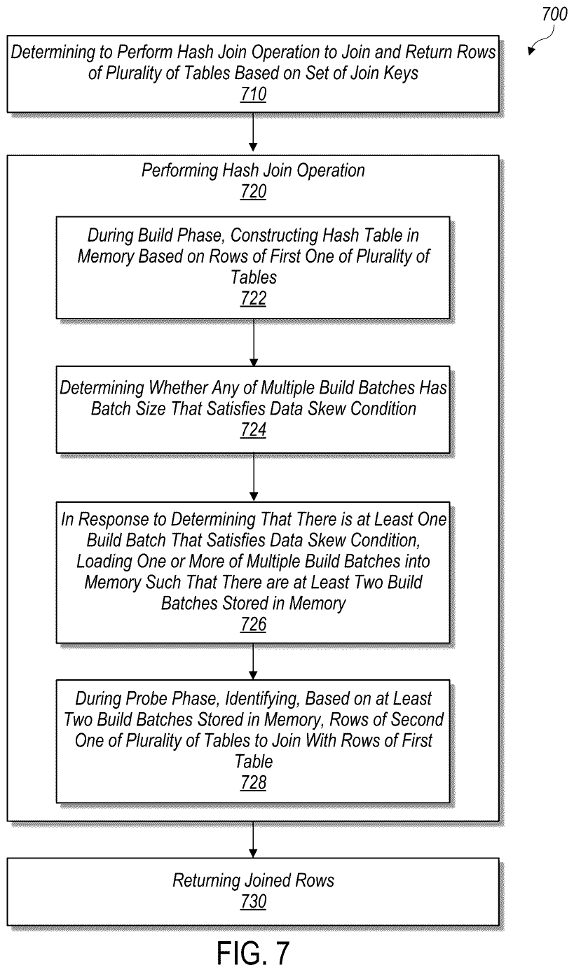

Turning now to FIG. 6, a block diagram of one embodiment of another portion of a hash join operation is shown. In the illustrated embodiment, there is memory 140, disk 150, and probe module 175. As further shown, memory 140 includes hash table 160, disk 150 initially includes build batches 165C-Z and corresponding probe batches 510, and probe module 175 includes hash function 200 and row matcher 500. Also as shown, hash table 160 initially stores build batches 165A and 165B

After iterating through rows 125 of outer table 120, probe phase 176 may be complete, and probe module 175 may begin checking rows 125 stored in probe batches 510 against rows 125 of build batches 165 that constitute hash table 160. Accordingly, as shown, build batches 165A and 165B (which were checked during probe phase 176) are evicted from memory 140 and build batches 165C and 165D are loaded into memory 140 from disk 150. Hash join engine 170 may implemented similar reload operations as those performed in reload phase 174. More specifically, in various embodiments, hash join engine 170 (or particularly, reload module 173) iterates through the remaining build batches 165 on disk 150 that were not assessed previously during reload phase 174 (e.g., because the memory limit was hit) and loads non-skewed build batches 165 into memory 140.

After one or more build batches 165 have been loaded into memory 140 as part of hash table 160, in various embodiments, probe module 175 accesses outer table rows 125 from the corresponding one or more probe batches 510 on disk 150. In the illustrated embodiment, build batches 165C and 165D are loaded into memory 140 and thus probe module 175 accesses rows 125 from probe batches 510C and 510D. Similar to the process discussed above, the join key values of those rows 125 are hashed using hash function 200 to generate hash values that are passed to row matcher 500. Row matcher 500 may then check build batches 165C and 165D for matching inner table rows 125 based on the hash values of the outer table rows 125. If an outer table row 125 does not match an inner table row 125, then that outer table row may be discarded. But if that outer table row finds a match, then the matching row 125 from inner table 120 and the row 125 from outer table 120 may be emitted as part of a result of the hash join operation. This process in FIG. 6 may be repeated until all build batches 165, including skewed batches, are processed. As such, build batches 165C and 165D that were loaded into memory may evicted and additional build batches 165 may be loaded into memory 140. Once all batches 165 have been processed, then database node 130 may return a result of the hash join operation (e.g., all matched rows 125) to the issuer of the hash join request (e.g., a client application that interacts with database node 130).

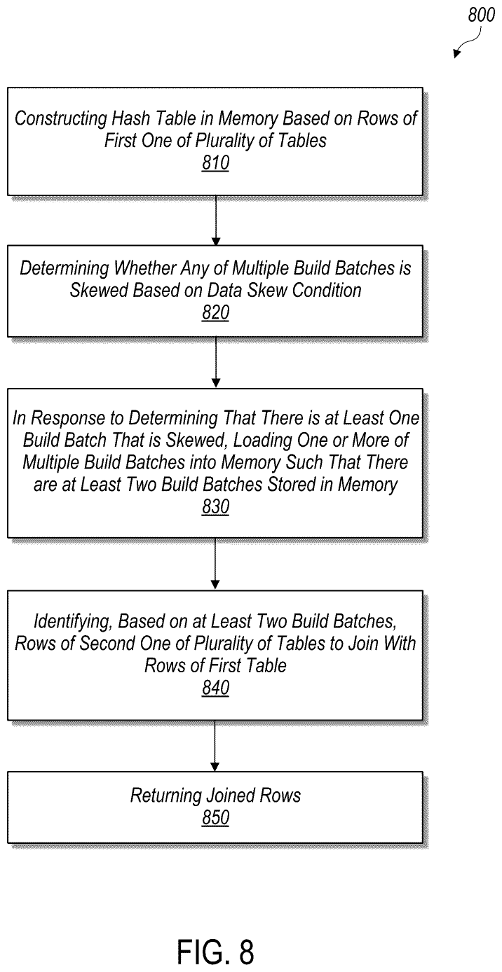

Turning now to FIG. 7, a flow diagram of a method 700 is shown. Method 700 is one embodiment of a method performed by a computer system (e.g., system 100) to implement a hash join operation. Method 700 may be performed by executing a set of program instructions stored on a non-transitory computer-readable medium. Method 700 may include more or fewer steps than shown. For example, method 700 may include another step after step 728 in which the computer system loads another set of build batches into a memory (e.g., memory 140).

Method 700 starts in step 710 with the computer system determining to perform a hash join operation to join and return rows (e.g., rows 125) of a plurality of tables (e.g., tables 120) based on a set of join keys. In step 720, the computer system performs the hash join operation. As part of performing the hash join operation, in step 722, during a build phase of the hash join operation, the computer system constructs a hash table (e.g., hash table 160) in a memory based on rows of a first one of the plurality of tables (e.g., inner table 120). The constructing may result in a plurality of build batches of rows (e.g., build batches 165), the plurality of build batches including one build batch stored in the memory and multiple build batches stored in a storage (e.g., disk 150) separate from the memory.

In step 724, the computer system determines whether any of the multiple build batches has a batch size that satisfies a data skew condition. The data skew condition may be satisfied by a given build batch when a number of rows of the given build batch exceeds a threshold number that is based on a total number of rows of the first table (e.g., a batch includes at least 30% of the rows). In various embodiments, the computer system maintains a list of skewed batches (e.g., skewed batch list 320) that specifies ones of the multiple build batches identified as skewed according to the data skew condition.

In step 726, in response to determining that there is at least one build batch that satisfies the data skew condition, the computer system loads one or more of the multiple build batches into the memory such that there are at least two build batches stored in the memory. The one or more build batches may be loaded from the storage into the memory in a sequential order defined by batch identifiers associated with the multiple build batches. In some embodiments, the computer system identifies a memory limit (e.g., 128 Megabytes) for storing batches in the memory (in a portion of the memory allocated for storing batches). In response to determining that loading another build batch would exceed the memory limit, the computer system ceases loading further build batches into the memory. The computer system may also exclude skewed batches from being loaded into the memory during the loading.

In step 728, during a probe phase of the hash join operation, the computer system identifies, based on the at least two build batches stored in the memory, rows of a second one of the plurality of tables (e.g., outer table 120) to join with the rows of the first table. During the probe phase, the computer system may determine whether a row of the second table maps to a build batch in the memory based on whether a first batch identifier associated with the row is not greater than a greatest batch identifier associated with the at least two build batches. In response to determining that the row does not map to a build batch in the memory, the computer system may write the row to one of a plurality of probe batches (e.g., probe batches 520) stored in the storage. In some cases, the row is written to the probe batch based on a second batch identifier associated with the row in response to one or more split operations being performed on a particular one of the multiple build batches that is associated with the first batch identifier.

During the probe phase, the computer system may also determine whether a row of the second table maps to a particular build batch that satisfies the data skew condition based on whether a batch identifier associated with the row matches a batch identifier of the particular build batch. In response to determining that the row maps to the particular build batch, the computer system may write the row to one of a plurality of probe batches stored in the storage. In various embodiments, the computer system omits a row from the second table by not writing the row to the storage based on the row mapping to an empty build batch in the memory. The empty build batch indicates an absence of matching rows from the first table. After assessing the rows of the second table against the at least two build batches stored in the memory, the computer system may remove the build batches from the memory and loading additional ones of the multiple build batches into the memory. In step 730, the computer system returns joined rows.

Turning now to FIG. 8, a flow diagram of a method 800 is shown. Method 800 is one embodiment of a method performed by a computer system (e.g., system 100) to implement a hash join operation. Method 800 may be performed by executing a set of program instructions stored on a non-transitory computer-readable medium. Method 800 may include more or fewer steps than shown. For example, method 800 may include another step after step 840 in which the computer system loads another set of build batches into a memory (e.g., memory 140).

Method 800 begins in step 810 with the computer system constructing a hash table (e.g., hash table 160) in a memory based on rows of a first one of a plurality of tables (e.g., inner table 120) involved in the hash join operation The constructing may result in one build batch that is stored in the memory and multiple build batches that are stored in a storage (e.g., disk 150) separate from the memory. In step 820, the computer system determines whether any of the multiple build batches is skewed based on a data skew condition.

In step 830, in response to determining that there is at least one build batch that is skewed, the computer system loads one or more of the multiple build batches into the memory such that there are at least two build batches stored in the memory. The one or more build batches may be loaded from the storage into the memory in a sequential order defined by batch identifiers associated with the multiple build batches. The loading of one or more build batches may be performed until loading another build batch would exceed a memory limit for storing batches in the memory. The loading of one or more build batches may include excluding any skewed build batches from being loaded into the memory during the loading.

In step 840, the computer system identifies, based on the at least two build batches, rows of a second one of the plurality of tables (e.g., outer table 120) to join with the rows of the first table. The computer system may write a row of the second table to a probe batch (e.g., a probe batch 520) stored in the storage in response to determining that the row maps to a skewed build batch of the multiple build batches. The computer system may write a row of the second table to a probe batch stored in the storage in response to determining that a batch identifier associated with the row does not match a batch identifier associated with the at least two build batches in the memory. In step 850, the computer system returns joined rows.

### Exemplary Computer System

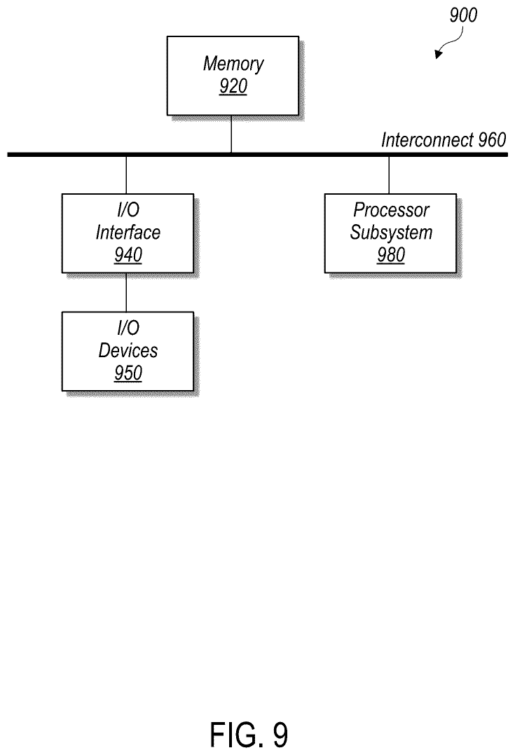

Turning now to FIG. 9, a block diagram of an exemplary computer system 900, which may implement system 100, database 110, and/or database node 130, is depicted. Computer system 900 includes a processor subsystem 980 that is coupled to a system memory 920 and I/O interfaces(s) 940 via an interconnect 960 (e.g., a system bus). I/O interface(s) 940 is coupled to one or more I/O devices 950. Although a single computer system 900 is shown in FIG. 9 for convenience, system 900 may also be implemented as two or more computer systems operating together.

Processor subsystem 980 may include one or more processors or processing units. In various embodiments of computer system 900, multiple instances of processor subsystem 980 may be coupled to interconnect 960. In various embodiments, processor subsystem 980 (or each processor unit within 980) may contain a cache or other form of on-board memory.

System memory 920 is usable store program instructions executable by processor subsystem 980 to cause system 900 perform various operations described herein. System memory 920 may be implemented using different physical memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 900 is not limited to primary storage such as memory 920. Rather, computer system 900 may also include other forms of storage such as cache memory in processor subsystem 980 and secondary storage on I/O Devices 950 (e.g., a hard drive, storage array, etc.). In some embodiments, these other forms of storage may also store program instructions executable by processor subsystem 980. In some embodiments, program instructions that when executed implement hash join engine 170, build module 171, reload module 173, and/or probe module 175 may be included/stored within system memory 920.

I/O interfaces 940 may be any of various types of interfaces configured to couple to and communicate with other devices, according to various embodiments. In one embodiment, I/O interface 940 is a bridge chip (e.g., Southbridge) from a front-side to one or more back-side buses. I/O interfaces 940 may be coupled to one or more I/O devices 950 via one or more corresponding buses or other interfaces. Examples of I/O devices 950 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 900 is coupled to a network via a network interface device 950 (e.g., configured to communicate over WiFi, Bluetooth, Ethernet, etc.).

The present disclosure includes references to an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more. ” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.” When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or”is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.” The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B. ” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.” Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to. ” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

What is claimed IS:

1. A method, comprising:
determining, by a computer system, to perform a hash join operation to join and return rows of a plurality of tables based on a set of join keys; and
performing, by the computer system, the hash join operation, including:
during a build phase, constructing a hash table in a memory based on rows of a first one of the plurality of tables, wherein the constructing results in a plurality of build batches of rows, the plurality of build batches including one build batch stored in the memory and multiple build batches stored in a storage separate from the memory;
determining whether any of the multiple build batches has a batch size that satisfies a data skew condition;
in response to determining that there is at least one build batch that satisfies the data skew condition, loading one or more of the multiple build batches into the memory such that there are at least two build batches stored in the memory;
during a probe phase, identifying, based on the at least two build batches stored in the memory, rows of a second one of the plurality of tables to join with the rows of the first table; and
returning joined rows.

2. The method of claim 1, further comprising:
identifying, by the computer system, a memory limit for storing batches in the memory; and
in response to determining that loading another build batch would exceed the memory limit, the computer system ceasing the loading of further build batches into the memory.

3. The method of claim 1, further comprising:
maintaining, by the computer system, a list of skewed batches that specifies ones of the multiple build batches identified as skewed according to the data skew condition; and
excluding the skewed batches from being loaded into the memory during the loading.

4. The method of claim 1, further comprising:
during the probe phase, the computer system:
determining whether a row of the second table maps to a build batch in the memory based on whether a first batch identifier associated with the row is not greater than a greatest batch identifier associated with the at least two build batches; and
in response to determining that the row does not map to a build batch in the memory, writing the row to one of a plurality of probe batches stored in the storage.

5. The method of claim 4, wherein the row is written to the probe batch based on a second batch identifier associated with the row in response to one or more split operations being performed on a particular one of the multiple build batches that is associated with the first batch identifier.

6. The method of claim 1, further comprising:
during the probe phase, the computer system:
determining whether a row of the second table maps to a particular build batch that satisfies the data skew condition based on whether a batch identifier associated with the row matches a batch identifier of the particular build batch; and
in response to determining that the row maps to the particular build batch, writing the row to one of a plurality of probe batches stored in the storage.

7. The method of claim 1, wherein the one or more build batches are loaded from the storage into the memory in a sequential order defined by batch identifiers associated with the multiple build batches.

8. The method of claim 1, further comprising:
omitting, by the computer system, a row from the second table without writing the row to the storage based on the row mapping to an empty build batch in the memory, wherein the empty build batch indicates an absence of matching rows from the first table.

9. The method of claim 1, further comprising:
after assessing the rows of the second table against the at least two build batches stored in the memory, the computer system removing the at least two build batches from the memory and loading additional ones of the multiple build batches into the memory.

10. The method of claim 1, wherein the data skew condition is satisfied by a given build batch when a storage size of the given build batch exceeds a threshold storage size that is based on a total storage size of the first table.

11. A non-transitory computer-readable medium having program instructions stored thereon that are capable of causing a computer system to perform operations comprising:
constructing a hash table in a memory based on rows of a first one of a plurality of tables involved in a hash join, wherein the constructing results in one build batch stored in the memory and multiple build batches stored in a storage separate from the memory;
determining whether any of the multiple build batches is skewed based on a data skew condition;
in response to determining that there is at least one build batch that is skewed, loading one or more of the multiple build batches into the memory such that there are at least two build batches stored in the memory;
identifying, based on the at least two build batches, rows of a second one of the plurality of tables to join with the rows of the first table; and
returning joined rows.

12. The non-transitory computer-readable medium of claim 11, wherein the loading of one or more build batches is performed until loading another build batch would exceed a memory limit for storing batches in the memory.

13. The non-transitory computer-readable medium of claim 11, wherein the loading of one or more build batches includes excluding any skewed build batches from being loaded into the memory during the loading.

14. The non-transitory computer-readable medium of claim 11, wherein the operations further comprise:
writing a row of the second table to a probe batch stored in the storage in response to determining that the row maps to a skewed build batch of the multiple build batches.

15. The non-transitory computer-readable medium of claim 11, wherein the operations further comprise:
writing a row of the second table to a probe batch stored in the storage in response to determining that a batch identifier associated with the row does not match a batch identifier associated with the at least two build batches in the memory.

16. A system, comprising:
at least one processor; and
memory having program instructions stored thereon that are executable by the at least one processor to cause the system to perform operations comprising:
constructing, during a build phase of a hash join, a hash table in the memory based on rows of a first one of a plurality of tables, wherein the constructing results in one build batch stored in the memory and multiple build batches stored in a storage separate from the memory;
determining whether any of the multiple build batches is skewed based on a data skew condition;
in response to determining that there is at least one build batch that is skewed, loading one or more of the multiple build batches into the memory such that there are at least two build batches stored in the memory; and
identifying, based on the at least two build batches during a probe phase of the hash join, rows of a second one of the plurality of tables to join with the rows of the first table.

17. The system of claim 16, wherein the loading of one or more build batches is performed until loading another build batch would exceed a memory limit of a portion of the memory allocated for storing batches.

18. The system of claim 16, wherein the loading of one or more build batches includes excluding any skewed build batches from being loaded into the memory during the loading.

19. The system of claim 16, wherein the one or more build batches are loaded from the storage into the memory in a sequential order defined by batch identifiers associated with the multiple build batches.

20. The system of claim 16, wherein the operations further comprise:
writing a row of the second table to a probe batch stored in the storage in response to determining that the row maps to a skewed build batch of the multiple build batches or a batch identifier associated with the row does not match a batch identifier associated with the at least two build batches in the memory.
